(19) United States
(12) Patent Application Publication
(10) Pub. No.: US 2013/0024439 A1
(43) Pub. Date: Jan. 24, 2013

(54) MODELING SEARCH IN A SOCIAL GRAPH

(71) Applicants: Paul Reinholdtsen, Woodinville, WA (US); Sandy Wong, Seattle, WA (US); Sreeharsha Kamireddy, Redmond, WA (US)

(72) Inventors: Paul Reinholdtsen, Woodinville, WA (US); Sandy Wong, Seattle, WA (US); Sreeharsha Kamireddy, Redmond, WA (US)

(73) Assignee: MICROSOFT CORPORATION, Redmond, WA (US)

(21) Appl. No.: 13/187,462

(22) Filed: Jul. 20, 2011

(51) Int. Cl. G06F 17/30

(52) U.S. Cl. 707/706; 707/E17.108

(57) ABSTRACT

Architecture that interfaces entities such as a search engine with a social network, by enabling both entities to share a common storage. Search behavior is modeled as a search social graph that incorporates both search behavior and user relationships. The data in the graph can be data mined, and related aggregations (stories) can be surfaced to users of the architecture via websites of both entities. To facilitate collaboration, users can further interact on the aggregations by repeating a query, commenting on a query, and/or suggesting links. This interactive feedback activity can also be modeled and recorded into the search social graph, which generates further aggregations. The positive feedback cycle, as part of the architecture, encourages collaboration and interaction on an aggregation.

### BACKGROUND

Searching is a solitary activity in that users are not able to collaborate or interact with friends or other people, for example. The storage of search behavior and social data are typically treated as data silos separated by website boundaries. Moreover, users are not able to utilize past experiences of friends in a direct manner. Since friends typically share similar interests, there is a high probability that they have made related searches in the past or have relevant knowledge that may be tapped. However, users can neither see the search-related activities of friends nor easily get help with searches.

Social networking sites are focused on recreational behavior (e.g., posting links of funny videos, posting things about which the user cares, etc.), and/or keeping friends up-to-date on current happenings. Users of social networking sites use their homepage as a news hub to see the latest state of users in the network. However, this view is limited to activity occurring on the social networking site and does not include activity occurring elsewhere like a search engine. There is no direct relationship between a user's search experience and user experience on a social networking site.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture interfaces a search engine with a social network by enabling both of the entities to share a common storage. Search behavior is modeled as a search social graph that incorporates both search behavior and user relationships. The data in the graph can be data mined, and related aggregations (also referred to as stories) can be surfaced to users of the architecture via websites of both entities. To facilitate collaboration, users can further interact on the aggregations by repeating a query, commenting on a query, suggesting a query, and/or suggesting links. This interactive feedback activity can also be modeled and recorded into the search social graph, which generates further aggregations. The positive feedback cycle, as part of the architecture, encourages collaboration and interaction on an aggregation.

In one implementation, the architecture comprises shared graph storage of user search activity and social relationship data, a graph model of search behavior and user relationships, an event aggregation service for event processing over the graph storage to present relevant aggregations of nodes and edges, the presentation of aggregations to users, and allowing the users to interact on the aggregations (e.g., re-query, comment, suggest, like, etc.), and a listening service that tracks actions on a website to record search behavior, collaborations (e.g., comments, likes, etc.), and changes in user relationships.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system that creates a shared storage of search and social network information in accordance with the disclosed architecture.

FIG. 2 illustrates an alternative embodiment of a system that employs a shared storage of search and social network information.

FIG. 3 illustrates a diagram of an example storage graph for utilization as shared storage illustrates

FIG. 4 illustrates a method in accordance with the disclosed architecture.

FIG. 5 illustrates further aspects of the method of FIG. 4.

FIG. 6 illustrates a block diagram of a computing system that executes a shared storage of search and social network information in accordance with the disclosed architecture.

### DETAILED DESCRIPTION

The disclosed architecture solves several problems associated with search engines, social network providers, and users. In other words, the architecture utilizes a social network as part of searching, keeps the social network informed about the user's current information needs and search activity, and facilitates collective collaboration on the search. The social networking site and search engine contribute to and share a common store, and use the common store to both record events and relationships, and to generate user-visible aggregations of events (also referred to as “stories”).

Previous storage solutions for search behavior focused on storage of search data around a single user. These are typically modeled as tables keyed off a user identifier. However, this does not allow the search engine to understand group behavior or see relationships between friends.

The disclosed architecture employs a storage solution that models search and user relationships as a graph. In one specific architectural model implementation, although capable of supporting many different relationship models, each user is a node, each query is a node, each search is a separate edge, collaborations such as “comments” and “likes” are modeled as data connected to the edge, and user-specific metadata regarding the search instance is modeled as metadata belonging to the edge.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

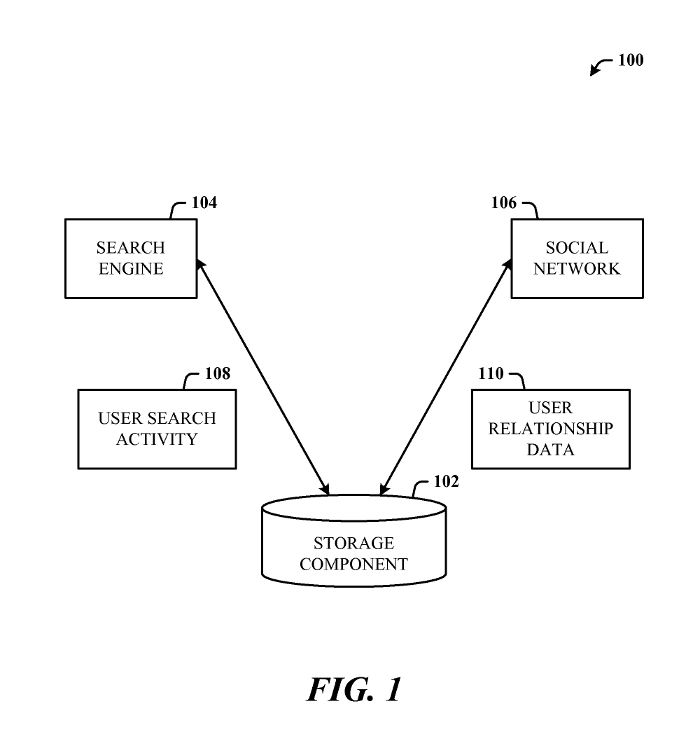

FIG. 1 illustrates a system 100 that creates a shared storage of search and social network information in accordance with the disclosed architecture. The system 100 includes a storage component 102 shared by both a search engine 104 and a social network 106. The storage component 102 stores user search activity 108 of a user associated with the search engine 104 and relationship data 110 of the social network 106 as a single storage model. The storage component 102 models user search data and user relationship data as a search social graph of nodes and node edges. The storage component 102 models the user search activity 108 and user relationship data 110 as a search social graph, where each user is a node, each query is a node, each search is a separate node edge, collaborations are data connected to an edge, and user-specific metadata of a search instance is modeled as metadata associated with an edge.

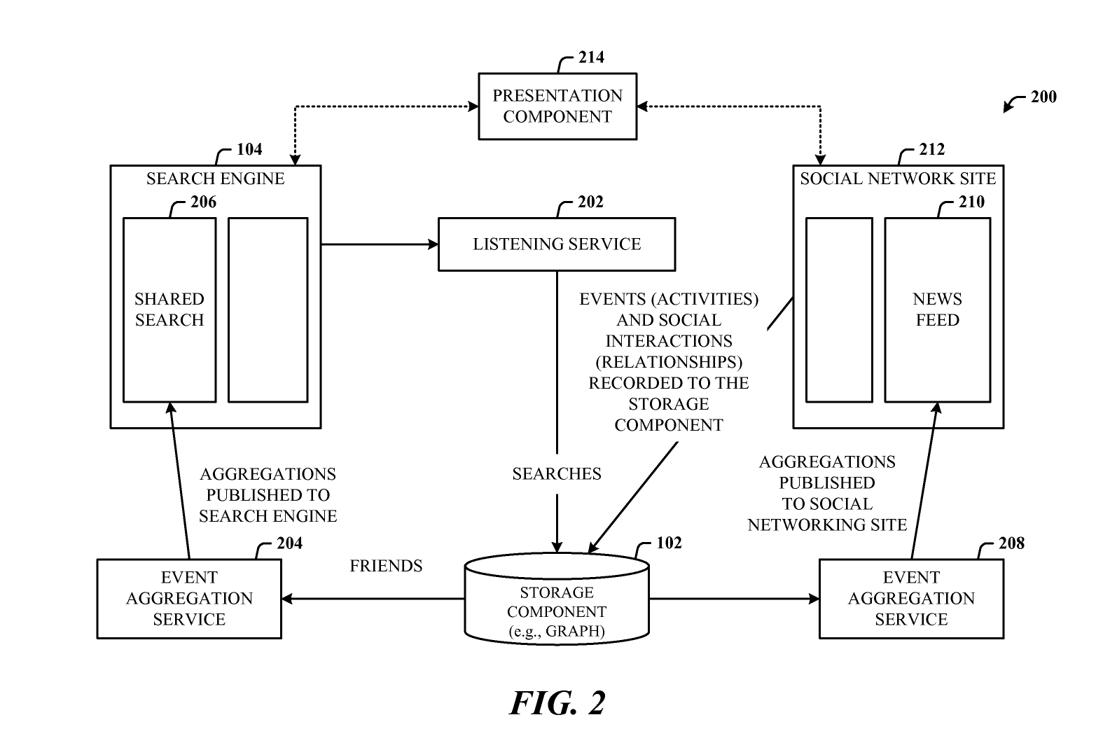

FIG. 2 illustrates an alternative embodiment of a system 200 that employs a shared storage of search and social network information. The system 200 includes entities and components of the system 100 of FIG. 1. The system 200 further comprises a listening service 202 that listens to and identifies actions on a website (search engine website) related to collaborations between users. The listening service 202 can also identify actions on a website (search engine website) related to changes in the relationship data (obtained from the social network). The listening service 202 can also identify actions on a website (search engine) related to search behavior of the user.

The system 200 can further comprise event aggregation services, such as a first event aggregation service 204 that obtains and returns relevant aggregations to a shared search 206 of the search engine 104, and a second event aggregation service 208 that performs event processing over the storage component 102 to present relevant aggregations to a news feed 210 of a social network website 212. The system 200 can further comprise a presentation component 214 that presents aggregations to users and enables user interaction with the aggregations. As illustrated, the presentation component 214 can be utilized only for the search engine side, the social network side, or a combination of both the search engine side and the social network side.

Put another way, a system is provided that comprises a storage component shared by both a search engine and a social network, the storage component stores user search activity of a user associated with the search engine and relationship data of the social network as a single storage model, an event aggregation service that performs event processing over the storage component to present relevant aggregations, a presentation component that presents aggregations to users and enables user interaction with the aggregations, and a listening service that identifies actions on a website related to the storage component. The storage component models search and user relationships as a search social graph. The listening service identifies actions on a website related to search behavior of the user, related to collaborations, and/or related to changes in the relationship data.

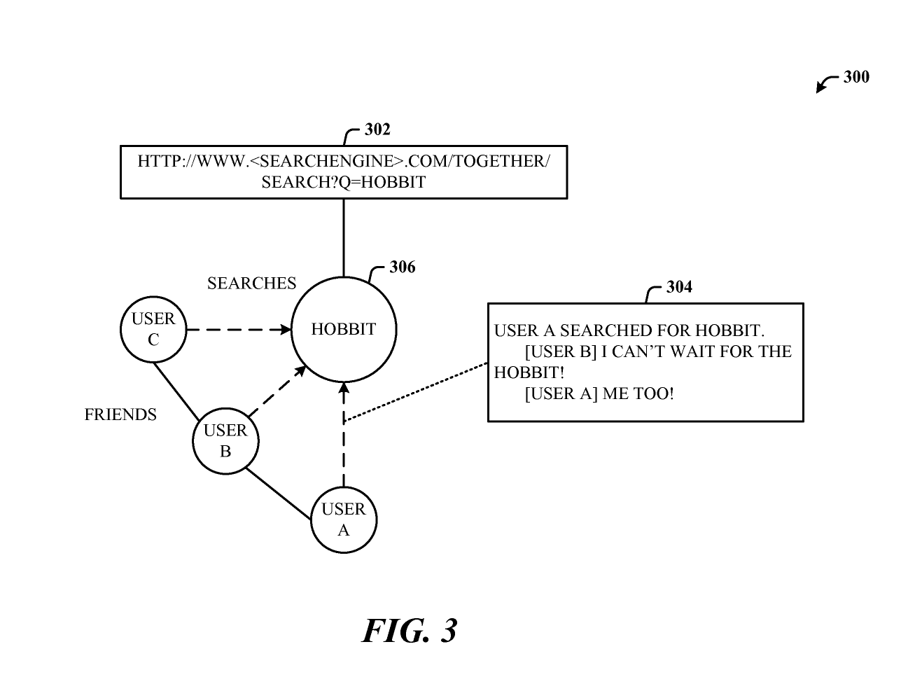

FIG. 3 illustrates a diagram 300 of an example storage graph for utilization as shared storage. For example, consider the following situation where User A is searching for information on an upcoming movie “The Hobbit”. User A searches for “hobbit” using a search engine (at the link 302). Thereafter, a friend, User B, sees a post (e.g., on a social website) indicating that User A is searching for “hobbit.” User B clicks on a link to go to the “hobbit” search engine result page (SERP). User B comments on the query and the comment appears on User A's search engine webpage, to which User A replies. User B's friend, User C, sees the story (the aggregation/interaction of Users A and B) (e.g., on the social website), which now shows that User A and User B searched for “hobbit”, annotated with both user's comments 304. Although User C cannot comment on the story because User C is User A's friend, User C can click on the link. These interactions engage friends and increase traffic between sites.

The diagram 300 shows a model of the objects involved in the above situation. The “hobbit” node 306 represents a SERP. Each dashed line represents a query action that connects a user to the “hobbit” SERP. User A's search connection to the “hobbit” node 306 functions as an anchor for data associated with the evolving situation.

When a user issues a query, the search engine communicates with the social network to associate the user with the query. In addition to the association itself, the search engine provides other information associated with the query, such as a relevant image or description. When a user clicks on (selects) a search result, this information is also sent to the social website. The search activity data enables the social networking site to create and surface stories related to a user's search activities. These aggregations can be augmented by the user and friends of the user by additional activities such as commenting and liking. These aggregations and activities may appear on the search website or the social website. The aggregations can have links that drive traffic between the search website and the social website thereby creating a virtuous cycle.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

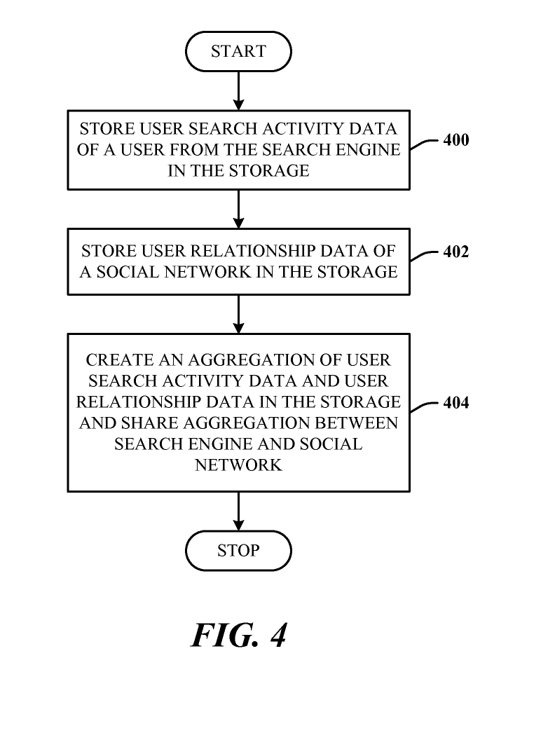

FIG. 4 illustrates a method in accordance with the disclosed architecture. At 400, user search activity data of a user from the search engine is stored in a shared storage. At 402, user relationship data of a social network is stored in the shared storage. At 404, an aggregation of the user search activity data and the user relationship data is created in the shared storage, and the aggregation is shared between the search engine and the social network.

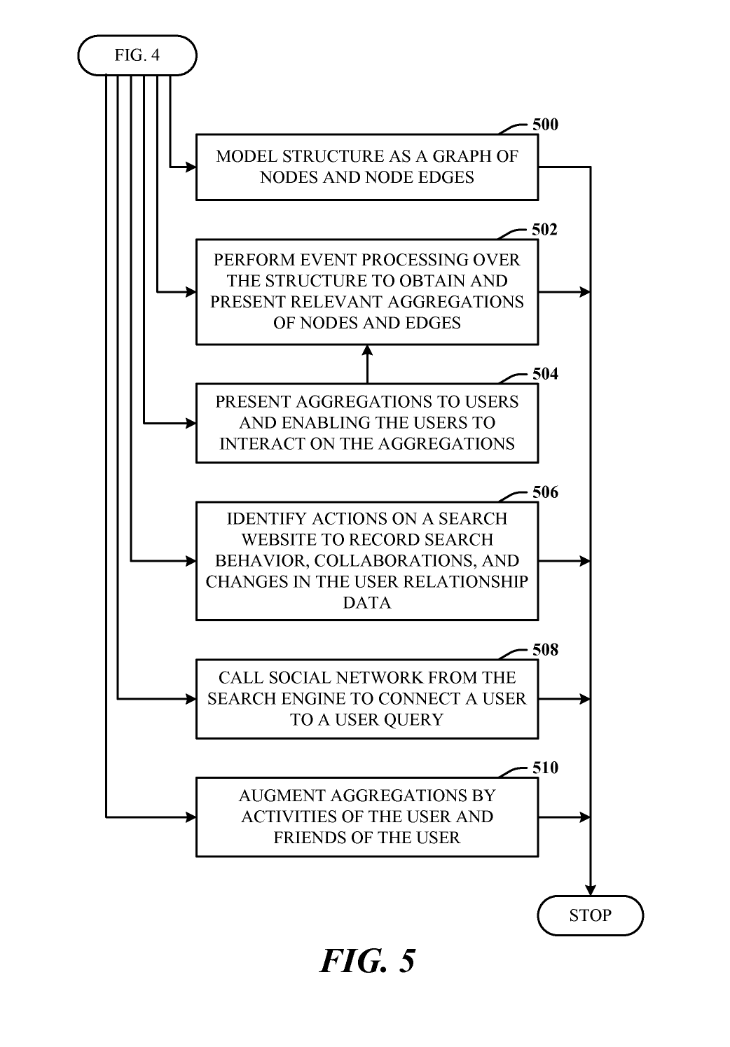

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, the structure is modeled as a graph of nodes and node edges. At 502, event processing is performed over the structure to obtain and present relevant aggregations of nodes and edges. At 504, the aggregations are presented to users and enable the users to interact on the aggregations. At 506, actions on a search website are identified to record search behavior, collaborations, and changes in the user relationship data. At 508, the social network is called from the search engine to connect a user to a user query. At 510, aggregations are augmented by activities of the user and friends of the user.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

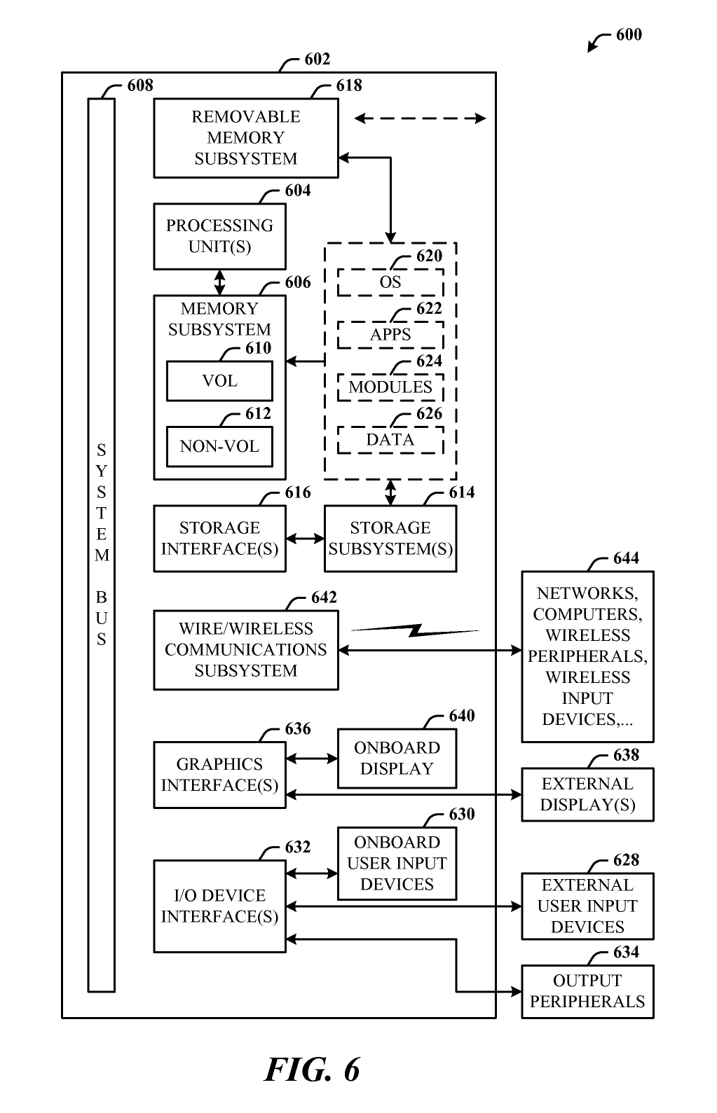

Referring now to FIG. 6, there is illustrated a block diagram of a computing system 600 that executes a shared storage of search and social network information in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include computer-readable storage (physical storage media) such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include entities and components of the system 100 of FIG. 1, entities and components of the system 200 of FIG. 2, entities and components of the diagram 300 of FIG. 3, and the methods represented by the flowcharts of FIGS. 4 and 5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 602 and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented system, comprising:
a storage component shared by both a search engine and a social network, the storage component stores user search activity of a user associated with the search engine and relationship data of the social network as a single storage model, wherein the social network comprises user friends who have relationships to the user; and
a microprocessor that executes computer-executable instructions associated with the storage component.

2. The system of claim 1, wherein the storage component models the user search activity and user relationship data as a search social graph of nodes and node edges.

3. The system of claim 1, further comprising an event aggregation service that performs event processing over the storage component to present relevant aggregations.

4. The system of claim 1, further comprising a presentation component that presents aggregations to users and enables user interaction with the aggregations.

5. The system of claim 1, further comprising a listening service that identifies actions on a website related to search behavior of the user.

6. The system of claim 1, further comprising a listening service that identifies actions on a website related to collaborations.

7. The system of claim 1, further comprising a listening service that identifies actions on a website related to changes in the relationship data.

8. The system of claim 1, wherein the storage component models the user search activity and user relationship data as a search social graph, where each user is a node, each query is a node, each search is a separate node edge, collaborations are data connected to an edge, and user-specific metadata of a search instance is modeled as metadata associated with an edge.

9. A computer-implemented system, comprising:
a storage component shared by both a search engine and a social network comprising user friends who have relationships to a user, the storage component stores user search activity of the user associated with the search engine and relationship data of the social network as a single storage model;
an event aggregation service that performs event processing over the storage component to present relevant aggregations;
a presentation component that presents aggregations to users and enables user interaction with the aggregations;
a listening service that identifies actions on a website related to the storage component; and
a microprocessor that executes computer-executable instructions associated with at least one of the storage component, the event aggregation service, the presentation component, or the listening service.

10. The system of claim 9, wherein the storage component models search and user relationships as a search social graph.

11. The system of claim 9, wherein the listening service identifies actions on a website related to search behavior of the user.

12. The system of claim 9, wherein the listening service identifies actions on a website related to collaborations.

13. The system of claim 9, wherein the listening service identifies actions on a website related to changes in the relationship data.

14. A computer-implemented method performed by a computer system executing machine-readable instructions, the method comprising acts of:
storing user search activity data of a user from the search engine in a shared storage;
storing user relationship data of a social network in the shared storage,, wherein the social network comprises user friends who have relationships to the user; and
aggregating the user search activity data and the user relationship data in the shared storage and sharing the aggregation between the search engine and the social network.

15. The method of claim 14, further comprising modeling the structure as a graph of nodes and node edges.

16. The method of claim 14, further comprising performing event processing over the structure to obtain and present relevant aggregations of nodes and edges.

17. The method of claim 16, further comprising presenting the aggregations to users and enabling the users to interact on the aggregations.

18. The method of claim 14, further comprising identifying actions on a search website to record search behavior, collaborations, and changes in the user relationship data.

19. The method of claim 14, further comprising calling the social network from the search engine to connect a user to a user query.

20. The method of claim 14, further comprising augmenting aggregations by activities of the user and friends of the user.
